(19) United States
(12) Patent Application Publication
(10) Pub. No.: US 2018/0035491 A1
(43) Pub. Date: Feb. 1, 2018

(54) COMPOSITION ENERGY UNIT

(71) Applicant: Bang Bang Textile Group Ltd., Wuxi (CN)

(72) Inventor: Luo Guigang, Wuxi (CN)

(21) Appl. No.: 15/496,391

(22) Filed: Apr. 25, 2017

(30) Foreign Application Priority Data
Aug. 1, 2016 (CN) 201610614123.3
Aug. 1, 2016 (CN) 201610621351.3

(51) Int. Cl. H05B 3/34; A41D 3/00; A41D 13/005; C09K 5/14

(52) U.S. Cl. CPC H05B 3/342; C09K 5/14; A41D 3/00; A41D 13/0051

(57) ABSTRACT

A composition energy unit includes a light-heating fabric that surrounds an electric-heating system. The light-heating fabric is formed from a plurality of light-heating nanofibers that absorb and release ambient thermal energy, each nanofiber being electrospun from a mixture comprised of metal complex pellets and polymer pellets. Each metal complex pellet includes metal, such as cesium tungsten complex or zirconium complex, which is mixed with a suitable dispersant. The electric-heating system includes an electrically-powered heating element that is trapped between layers of the light-heating fabric. When worn by an individual in a cold-weather environment, such as a lightweight and comfortable article of clothing, the composition energy unit relies upon two distinct sources of energy, thermal energy from the ambient environment as well as electrical battery power, to efficiently produce enough heat to sustain a suitable body temperature for an extended period of time.

### FIELD OF THE INVENTION

The present invention relates generally to the textile industry and, more particularly, to materials that are specifically designed to produce and/or retain thermal energy.

### BACKGROUND OF THE INVENTION

Prolonged exposure to cold temperatures in cold-weather environments can cause certain medical hazards. For instance, hypothermia is a dangerous medical condition which occurs when the human body dissipates heat at a rate that results in a significant drop in body temperature.

To prepare against such hazards, cold-weather clothing is commonly worn. As can be appreciated, cold-weather, or winter, apparel minimizes the dissipation of body heat and thereby ensures that the body temperature of an individual is maintained at a healthy level.

Certain materials are commonly utilized to maximize effectiveness in maintaining a suitable body temperature. Traditionally, thermal garments rely on relatively thick materials, such as fur, down feathers, cotton and other insulated fabrics, which are in turn often arranged in multiple layers, to create adequate warmth to the wearer. However, this design renders conventional cold-weather apparel rather bulky and heavy in nature. Due to its relative inflexibility and overall lack of comfort, cold-weather clothing is typically considered both unfashionable and unpleasant to wear.

In the textile industry, the use of nanofiber technology has gained recent prominence in the design of effective thermal protective clothing. By using polymer-based nanofibers applied with high thermal conductivity coatings, thinner and lighter articles of clothing have been manufactured that assist in the retention of body heat.

Although there have been advancements, winter apparel still remains relatively heavy, thick and inflexible. Furthermore, it has been found that winter apparel is still often incapable of maintaining an adequate body temperature for an extended period of time, particularly in extreme cold environments, such as a polar region.

### SUMMARY OF THE INVENTION

It is an object of the invention to provide a new and improved unit, or article, for retaining thermal energy in cold-weather environments.

It is another object of the present invention to provide a thermal energy article as described above that is designed to maintain the body temperature of an individual within a suitable range for an extended period of time, even in extreme cold conditions.

It is yet another object of the present invention to provide a thermal energy article as described above that is thin, light and comfortable to wear.

It is still another object of the present invention to provide a thermal energy article as described above that has a limited number of parts and is relatively inexpensive to manufacture.

Accordingly, as one feature of the present invention, there is provided a composition energy unit, comprising (a) a light-heating fabric adapted to absorb and release infrared thermal energy, the light-heating fabric being a metal-based fabric, and (b) an electric-heating system disposed at least partially within the light-heating fabric, the electric-heating system being electrically powered to produce infrared thermal energy, (c) wherein the light-heating fabric and electric-heating system operate independently of one another.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a top view of a composition energy unit constructed according to the teachings of the present invention; and

FIG. 2 is an enlarged, fragmentary, section view of the composition energy unit shown in FIG. 1.

### DETAILED DESCRIPTION OF THE INVENTION

### Composition Energy Unit 11

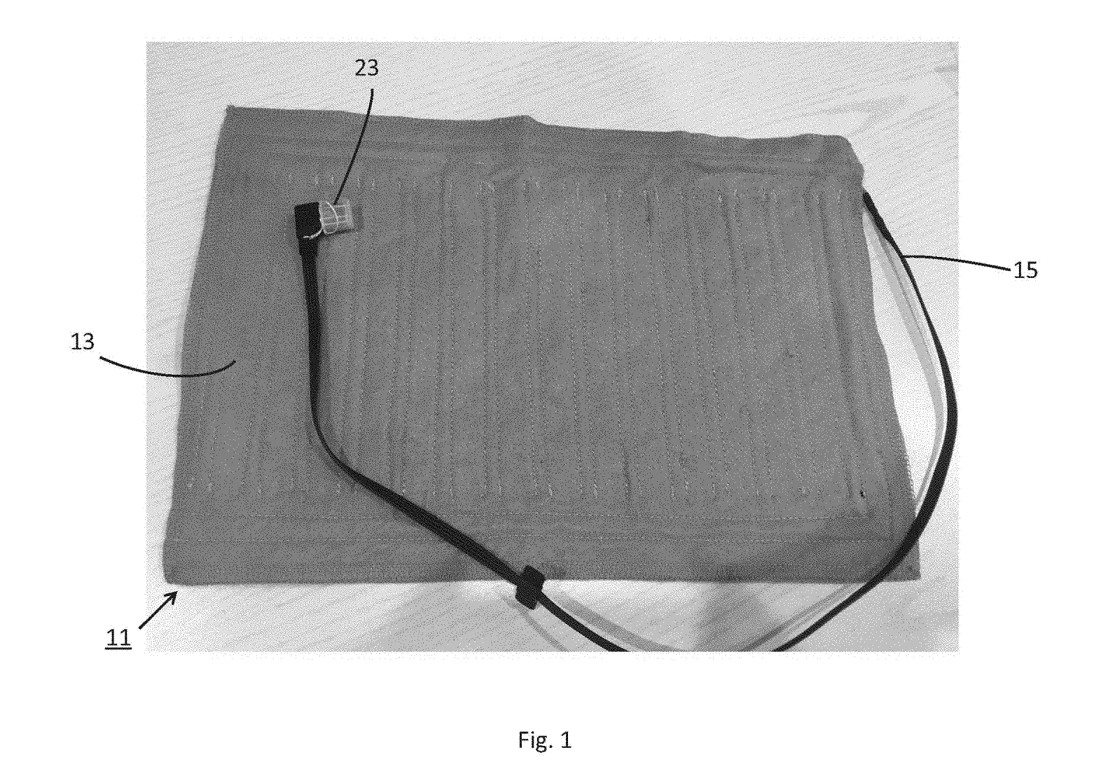

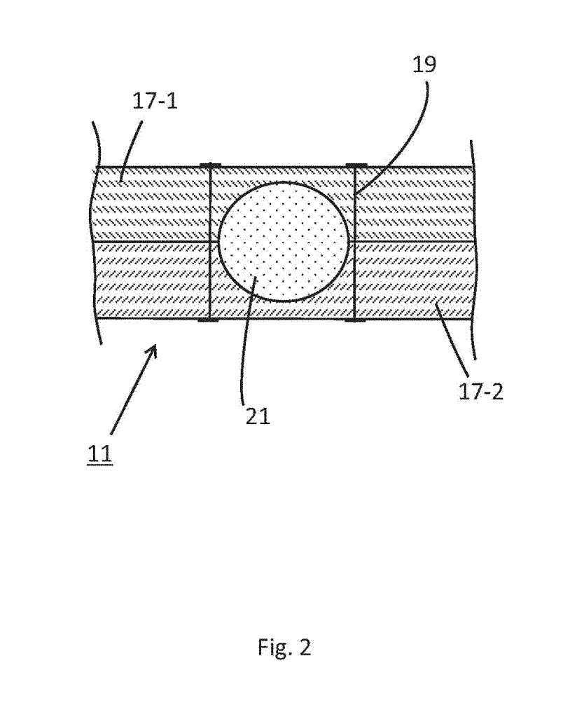

Referring now to FIGS. 1 and 2, there is a shown a composition energy unit which is constructed according to the teachings of the present invention, the composition energy unit being identified generally by reference numeral 11. As will be described further below, composition energy unit 11 is designed to generate heat using two separate and largely independent sources. In this manner, composition unit 11 is particularly well suited to maintain the body temperature of an individual at an acceptable level in cold-weather environments for an extended period of time.

For simplicity purposes only, composition energy unit 11 is represented herein as a generally rectangular swatch. However, in the preferred application of the present invention, composition energy unit 11 is preferably configured as an article of clothing, such as a jacket. In this manner, a person can be most effectively warmed by simply wearing the article.

Nonetheless, it should be noted that unit 11 is not limited to any particular size, shape or configuration. Rather, it is to be understood that composition energy unit 11 could be constructed in a wide variety of different forms which are suitable for providing warmth to an individual, such as in the shape of a unitary blanket, sheet, automotive seat or the like, without departing from the spirit of the present invention.

As referenced briefly above, composition, or thermal, energy unit 11 utilizes two separate and largely independent means of producing thermal energy, namely, (i) a light-heating fabric 13 that substantially surrounds, or envelops, (ii) an electric-heating system 15. Through the use of dual, independent and redundant thermal energy sources, unit 11 is highly effective in maintaining the body temperature of an individual within a target temperature range for an extended period of time, even in extreme cold conditions. Furthermore, composition energy unit 11 achieves the aforementioned thermal requirements while maintaining a thin, light and flexible construction, which is a principal object of the present invention.

### Light-Heating Fabric 13

Light-heating fabric 13 is preferably a metal-based, needle-punched, nonwoven fabric that both absorbs and releases safe infrared thermal energy within its immediate environment. By drawing thermal energy from other resources (e.g., the sun or electric-heating system 15), fabric 13 is able to provide enough heat to maintain the body temperature of an individual within a safe range for an extended period of time, which is highly desirable.

For ease in manufacturing unit 11, light-heating fabric 13 is represented herein as comprising a first fabric layer 17-1 and a second fabric layer 17-2 that are secured together along their respective peripheries and in a designated pattern within its interior region using a thread-based stitching 19. As will be explained further below, stitching 19 serves to retain electric-heating element 15 fixedly in place between layers 17-1 and 17-2.

It should be noted that, in lieu of stitching 19, alternative means for securing layers 17-1 and 17-2 together could be realized without departing from the spirit of the present invention. For instance, layers 17-1 and 17-2 could be selectively bonded together using an appropriate adhesive.

Fabric 13 is preferably formed using light-heating nanofibers, the construction of which is novel and, as such, serves as a principal feature of the present invention. Each nanofiber in fabric 13 effectively absorbs infrared thermal energy from its immediate environment which, in turn, causes the nanofiber itself to warm to the extent so as to generate considerable heat.

Notably, within one minute of exposure to the sun in a temperature environment of approximately 1° C. (33.8° F.) to approximately 3° C. (37.4° F.), each nanofiber experiences a commensurate rise in temperature in the range from approximately 25° C. (77° F.) to approximately 40° C. (104° F.), which is approximately three times greater than the temperature rise of conventional fibers. Because the wavelength of the infrared thermal energy released by fabric 13 is similar to the wavelength of thermal energy released by the human body, fabric 13 is safe to wear. Furthermore, the construction of each nanofiber renders fabric 13 in compliance with both the Standard 100 by OEKO-TEX® and the REACH 2016 textile certification standards.

Each light-heating nanofiber is constructed from a mixture comprising (a) metal complex pellets and (b) polymer pellets, each type of pellet having a preferred range in diameter from approximately 1.5 nm to approximately 2.0 nm. The mixture of pellets is, in turn, electrospun together through a process that includes the steps of drying, melting, spinning, steaming, fixing, cutting and packing. It should be noted that the metal complex pellets and the polymer pellets may constitute the entirety of the nanofiber mixture or, in the alternative, the nanofiber mixture may include certain additional materials not referenced herein.

The resultant light-heating nanofiber created through the electrospinning process referenced above preferably has a denier in the range of approximately 1.5 d to approximately 20.0 d and a length in the range of approximately 25 mm to approximately 200 mm. However, it is to be understood that the specifications associated with each nanofiber could be modified without departing from the spirit of the present invention.

The specific composition of each metal complex pellet is provided in further detail below. Each polymer pellet is preferably formed of a material from the group consisting of polyester, nylon, acrylic, polypropylene, viscose, or a combination thereof. Most preferably, each polymer pellet is in the form of a semi-dull polyester pellet.

In the preferred mixture for each nanofiber, the metal complex pellets preferably constitute approximately 5% to 20% of the mixture. More narrowly, the metal complex pellets preferably constitute approximately 7% to 18% of the mixture. However, through extensive testing, it has been determined that optimum results are achieved when the metal complex pellets constitute 10% to 15% of the mixture.

Correspondingly, in view of the above, the polymer pellets preferably constitute approximately 80% to 95% of the mixture used to create each nanofiber. More narrowly, the polymer pellets preferably constitute approximately 82% to 93% of the mixture. However, through extensive testing, it has been determined that optimum results are achieved when the polymer pellets constitute 85% to 90% of the mixture.

The metal complex used in the mixture to form each nanofiber preferably includes a metal and a dispersant. It should be noted that the metal and the dispersant may constitute the entirety of the metal complex or, in the alternative, the metal complex may include certain additional materials not referenced herein.

The metal used to form the pellets of the metal complex is preferably cesium tungsten complex or zirconium complex. This metallic material used to form the metal pellets is preferably provided in powdered form with a diameter in the range of approximately 10 nm to approximately 30 nm, more narrowly, with a diameter in the range of approximately 15 nm to approximately 25 nm, and even more narrowly, with a diameter in the range of approximately 18 nm to approximately 23 nm.

In the mixture used to form the metal complex, the metal (e.g., cesium tungsten complex or zirconium complex) preferably constitutes approximately 40% to 80% of the mixture and the dispersant preferably constitutes at least the majority of the remaining 20% to 60% of the mixture. Most preferably, in the mixture for the metal complex, the metal constitutes approximately 60% of the mixture and the dispersant constitutes approximately 40% of the mixture.

### Electric-Heating System 15

As referenced briefly above, electric-heating system 15 provides an independent, redundant heating source to thermal energy unit 11. In other words, when light-heating fabric 13 is incapable of producing adequate thermal energy (e.g., in an environment with limited infrared energy to be absorbed and subsequently released), electric-heating system 15 provides the necessary thermal energy to maintain the body temperature of an individual within a desired temperature range.

Electric-heating system 15 comprises at least one heating element 21 that is disposed within fabric 13 (i.e. between layers 17-1 and 17-2). Heating element 21 is in the form of any thermally conductive element that converts electricity into heat through a process of resistive heating. For instance, heating element 21 may be in the form of an elongated, continuous, metallic resistance wire.

In the present embodiment, heating element 21 is arranged in thermally optimal configuration between layers 17 (e.g. as a planar ribbon or coil spread evenly to create uniform energy dispersion). A first end of element 21 terminates between layers 17, whereas a second end of element 21 preferably extends to the periphery of fabric 13 so as to be externally accessible. As seen most clearly in FIG. 1, stitching 19 is preferably applied immediately surrounding conductive element 21. In this manner, heating element 21 is retained in a fixed relationship relative to fabric 13.

Conductive element 21 is adapted for electrical connection to a power source. For instance, as represented herein, the second end of heating element 21 is electrically connected to a USB-type connector 23. In turn, connector 23 is adapted for direct electrical coupling to a designated external power source, such as a battery (not shown).

For instance, electric-heating system 15 is designed to be powered by a 3-9 volt (preferably 5 volt) lithium battery with a current of approximately 1-2 amperes, thereby rendering system 15 compliant with both IEC 227 and IEC 228 certification standards. However, electric-heating system 15 could be powered by alternative electrical sources without departing from the spirit of the present invention.

For ease of recharging and/or replacement, the battery is preferably located outside of fabric 13. However, it is to be understood that the entirety of electric-heating system 15, including the electrical power source, could be located entirely within fabric 13 without departing from the spirit of the present invention.

### Measured Test Results Achieved Using Unit 11

A pair of actual composition energy units 11 was constructed in accordance with the teachings set forth in detail above. In turn, each unit 11 was tested in specific cold-weather conditions to measure its effectiveness in producing thermal energy. The results of such testing are provided herein. However, it is to be understood that the results are being provided for illustrative purposes only and are not to be construed in a limiting fashion.

In connection with a first testing process, a first embodiment of a composition energy unit 11 was constructed in which light-heating fabric 13 was formed using nanofibers constructed from a mixture consisting of 5% metal complex pellets and 95% polymer pellets. The fabric 13 was shaped into a generally rectangular swatch having a length of approximately 25 cm and a width of approximately 15 cm.

With a 5 v battery connected to electric-heating system 15, the first embodiment of composition energy unit 11 was able to operate for over 5 hours producing the necessary heat to maintain an individual within a desired temperature range. Through the use of the dual heating sources (i.e. light-heating and electrical-heating sources), the first embodiment of composition energy unit 11 was able to effectively create, within two minutes, an immediate thermal environment with a temperature of approximately 30° C. (86° F.). Upon withdrawal of the electric-heating source (i.e. the battery), the unit 11 returned to the ambient temperature after approximately 9 minutes, which is approximately three times longer than conventional materials.

In connection with a second testing process, a second embodiment of a composition energy unit 11 was constructed in which light-heating fabric 13 was formed using nanofibers constructed from a mixture consisting of 10% metal complex pellets and 90% polymer pellets. The fabric 13 was shaped into a generally rectangular swatch having a length of approximately 25 cm and a width of approximately 15 cm.

With a 5 v battery connected to electric-heating system 15, the second embodiment of composition energy unit 11 was able to effectively create, within two minutes, an immediate thermal environment with a temperature of approximately 34° C. (93.2° F.). Upon withdrawal of the electric-heating source (i.e. the battery), the unit 11 returned to the ambient temperature after approximately 12 minutes, which is approximately four times longer than conventional materials.

It should be noted that the first and second embodiments of composition thermal energy units 11, which were constructed in the manner set forth above, had an overall weight in the range from of approximately 40 gm (0.088 lbs) to approximately 60 gm (0.132 lbs). Accordingly, it is readily apparent that composition energy units 11 of the type as set forth above can be mass produced while maintaining a thin, light and comfortable construction. Additionally, each actual unit 11 was repeatedly washed and did not experience any compromised operability.

The embodiments shown above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A composition energy unit, comprising:
(a) a light-heating fabric adapted to absorb and release infrared thermal energy, the light-heating fabric being a metal-based fabric; and
(b) an electric-heating system disposed at least partially within the light-heating fabric, the electric-heating system being electrically powered to produce infrared thermal energy;
(c) wherein the light-heating fabric and electric-heating system operate independently of one another.

2. The composition energy unit of claim 1 wherein the light-heating fabric is formed from a plurality of light-heating nanofibers.

3. The composition energy unit of claim 2 wherein each of the plurality of light-heating nanofibers is constructed from a mixture comprising:
(a) a plurality of metal complex pellets; and
(b) a plurality of polymer pellets.

4. The composition energy unit of claim 3 wherein the plurality of metal complex pellets constitutes approximately 5% to approximately 20% of the mixture for the plurality of light-heating nanofibers.

5. The composition energy unit of claim 4 wherein the plurality of metal complex pellets constitutes approximately 10% to approximately 15% of the mixture for the plurality of light-heating nanofibers.

6. The composition energy unit of claim 5 wherein the plurality of polymer pellets constitutes approximately 80% to approximately 95% of the mixture for the plurality of light-heating nanofibers.

7. The composition energy unit of claim 6 wherein the plurality of polymer pellets constitutes approximately 85% to approximately 90% of the mixture for the plurality of light-heating nanofibers.

8. The composition energy unit of claim 3 wherein the plurality of metal complex pellets and the plurality of polymer pellets are mixed through an electrospinning process.

9. The composition energy unit of claim 3 wherein each of the plurality of polymer pellets is selected from the group consisting polyester, nylon, acrylic, polypropylene, viscose, or a combination thereof.

10. The composition energy unit of claim 3 wherein each of the plurality of metal complex pellets is formed from a mixture comprising a metal and a dispersant.

11. The composition energy unit of claim 10 wherein the metal is selected from a group consisting of cesium tungsten complex and zirconium complex.

12. The composition energy unit of claim 11 wherein the metal constitutes approximately 60% of the mixture for the plurality of metal complex pellets.

13. The composition energy unit of claim 12 wherein the dispersant constitutes approximately 40% of the mixture for the plurality of metal complex pellets.

14. The composition energy unit of claim 1 wherein the electric-heating system comprises at least one heating element that converts electricity into heat.

15. The composition energy unit of claim 14 wherein the electric-heating system comprises a connector in electrical communication with the at least one heating element, the connector being adapted for connection with an electrical power source.

16. The composition energy unit of claim 15 the light-heating fabric comprises a first fabric layer and a second fabric layer that are selectively secured together.

17. The composition energy unit of claim 16 wherein the at least one heating element for the electric-heating system is fixedly disposed at least partially between the first fabric layer and the second fabric layer.

18. The composition energy unit of claim 17 wherein the first fabric layer and the second fabric layer are selectively secured together by stitching.
